(19) United States
(12) Patent Application Publication
(10) Pub. No.: US 2026/0141253 A1
(43) Pub. Date: May 21, 2026

(54) METHOD AND SYSTEM FOR DETERMINING OPTIMAL DRIVING BEHAVIOR OF AUTONOMOUS VEHICLES BASED ON REINFORCEMENT LEARNING

(71) Applicant: ELECTRONICS AND TELECOMMUNICATIONS RESEARCH INSTITUTE, Daejeon (KR)

(72) Inventors: Kyoung-Wook Min, Daejeon (KR); Jinhong NOH, Daejeon (KR)

(21) Appl. No.: 19/085,069

(22) Filed: Mar. 20, 2025

(30) Foreign Application Priority Data
Nov. 20, 2024 (KR) 10-2024-0166553

(51) Int. Cl. G06N 3/092; B60W 60/00

(52) U.S. Cl. CPC G06N 3/092; B60W 60/0027

(57) ABSTRACT

The present specification provides a driving behavior determination apparatus for determining the driving behavior of an autonomous vehicle through reinforcement learning. More specifically, the driving behavior determination apparatus includes: a perception module that collects driving logging data from all directions of the autonomous vehicle through multiple sensors to recognize surrounding dynamic and static objects; a decision module that generates a learning dataset from the driving logging data, classifies the learning dataset by scenario and driving difficulty, predicts the future driving trajectory through past driving trajectories from the learning dataset, and generates the driving trajectory of the autonomous vehicle by updating the parameters of the reinforcement learning model to maximize the reward between the predicted future driving trajectory and the actual driving trajectory; and a control module that controls the driving behavior of the autonomous vehicle based on the generated driving trajectory.

### CROSS-REFERENCE TO RELATED APPLICATION(S)

This application claims priority to and the benefit under 35 USC § 119 of Korean Patent Application No. 10-2024-0166553, filed on Nov. 20, 2024, in the Korean Intellectual Property Office, the entire disclosures of which are incorporated herein by reference for all purposes.

### BACKGROUND

### 1. Technical Field

The present specification relates to a method for determining the driving behavior of an autonomous vehicle, and more specifically, to a method for determining the driving behavior of an autonomous vehicle through reinforcement learning and an apparatus that supports this method.

### 2. Description of Related Art

A typical Autonomous Driving System (ADS) operates by going through the processes of perception, decision-making, and control to drive the vehicle.

The perception process involves utilizing data acquired from multiple sensors (e.g., cameras, LiDAR, radar, etc.) to recognize static or dynamic objects around the vehicle. The decision-making process determines the driving behavior (e.g., stop, drive, avoid, overtake, pass an intersection, etc.) based on the outcomes of the perception process, such as assessing collision risks. It then generates the corresponding driving path (or regional path, trajectory). The control process performs longitudinal or lateral control to follow the generated driving path.

Conventional autonomous driving decision-making technologies (such as rule-based decision-making or simulation-based reinforcement learning) have the following limitations.

First, rule-based decision-making involves the developer defining rules and implementing corresponding programs. For example, if the traffic light is red, the vehicle stops at the stop line; if the vehicle ahead has its emergency lights on and is stationary, the vehicle avoids it. In this manner, specific driving behaviors are determined by defining rules for each situation, and the driving path corresponding to each behavior is generated. However, there is a limitation in that the developer cannot define rules for every possible driving situation. As a result, it is not possible to handle all scenarios (such as behavior determination and path generation) effectively. If a new situation arises, it becomes difficult to collect data for that situation, analyze it, define rules, and develop an algorithm to determine appropriate behavior.

Next, in simulation-based reinforcement learning, the concept of reinforcement learning is to observe the state of the environment and learn the agent's policy to reinforce behaviors that yield greater rewards. This improves performance through countless trial and error repetitions. For example, it is similar to learning how to achieve a higher score in a game by repeatedly trying different actions to obtain more points.

Most reinforcement learning is performed through simulations. This is because performing the process of gaining or losing rewards in a real environment may cause damage to the agent (e.g., a vehicle, robot, etc.) or the surrounding environment.

Therefore, autonomous driving simulations have limitations, including constraints in simulating various input sensors and inadequacies in modeling the dynamic movements of vehicles. When reinforcement learning for autonomous driving is performed using simulations with these limitations, high performance cannot be guaranteed.

### SUMMARY

Therefore, the only method that can be directly applied to autonomous vehicles is to collect a vast amount of real-world driving datasets for various scenarios (such as quiet, congested, complex, and dangerous situations), including the motion of the ego vehicle and the surrounding objects, and then perform reinforcement learning based on these datasets.

Therefore, the present specification aims to provide a method for determining the optimal behavior of an autonomous vehicle (including generating driving paths) through reinforcement learning based on real-world driving datasets, in order to overcome the limitations of the previously discussed autonomous driving decision-making technologies.

More specifically, the present specification aims to provide a method for determining the optimal driving behavior of an autonomous vehicle, including trajectory (comprising position, orientation, and speed), by collecting driving data of surrounding vehicles and the ego vehicle in various situations and performing reinforcement learning based on this data.

The technical problems to be addressed by the present invention are not limited to those mentioned above. Other unmentioned technical problems may become clearly understood by a person skilled in the relevant technical field based on the descriptions provided below.

The present specification describes a driving behavior determination apparatus for determining a driving behavior of an autonomous vehicle through reinforcement learning, characterized by comprising a perception module that collects driving logging data from all directions of the autonomous vehicle through multiple sensors and recognizes surrounding dynamic and static objects; a decision module that generates a learning dataset from the driving logging data, classifies the learning dataset by scenario and driving difficulty, predicts the future driving trajectory based on past driving trajectories from the learning dataset, and generates the driving trajectory of the autonomous vehicle by updating the parameters of a reinforcement learning model to maximize the reward between the predicted future driving trajectory and the actual driving trajectory; and a control module that controls the driving behavior of the autonomous vehicle based on the generated driving trajectory.

Furthermore, in the present specification, the decision module is characterized by comprising: A learning dataset generation unit that extracts data related to reinforcement learning from the driving logging data and generates a learning dataset, and classifies the generated learning dataset by scenario and driving difficulty; and a data learning unit that predicts the future driving trajectory from the inputs of past driving trajectories derived from the learning dataset and updates the parameters of the reinforcement learning model to maximize the reward between the predicted future driving trajectory and the actual driving trajectory.

Furthermore, in the present specification, the decision module is characterized by further comprising a model evaluation unit that performs learning in the order of low driving difficulty to high driving difficulty and conducts progress evaluation for each driving difficulty.

Furthermore, in the present specification, the learning dataset is characterized by comprising ego information, object information surrounding the autonomous vehicle, rear light information of a vehicle located ahead of the autonomous vehicle, signal information from traffic lights, and information about the drivable area of the autonomous vehicle.

Furthermore, in the present specification, the ego information is characterized by comprising a position, size, direction, speed, and steering angle of the autonomous vehicle.

Furthermore, in the present specification, the surrounding object information is characterized by comprising information about surrounding dynamic objects and static objects.

Furthermore, in the present specification, the classification by scenario is characterized by being performed based on road structure analysis through matching the driving position of the autonomous vehicle with data from a high-definition map (HDMap), or based on the motion information of the autonomous vehicle caused by surrounding vehicles using the behavioral data of the autonomous vehicle.

Furthermore, in the present specification, the driving difficulty classified by the decision module is characterized by being based on collision risk.

Furthermore, in the present specification, the collision risk is characterized by being calculated by determining the object collision probability based on the predicted future trajectory information of surrounding dynamic objects and the actual driving trajectory of the autonomous vehicle.

Furthermore, in the present specification, the reward is characterized by comprising a safety-related reward based on the autonomous driving failure rate, an efficiency-related reward based on the autonomous driving progress rate, and a comfort-related reward defined by the ride comfort, which is measured by the deceleration rate.

Furthermore, in the present specification. a method for determining the driving behavior of an autonomous vehicle through reinforcement learning, characterized by comprising the steps of: collecting driving logging data from all directions of the autonomous vehicle through multiple sensors; generating a learning dataset from the driving logging data; Classifying the learning dataset by scenario and driving difficulty; predicting the future driving trajectory based on the classified learning dataset and updating the parameters of the reinforcement learning model to maximize the reward, thereby generating the driving trajectory of the autonomous vehicle; and controlling the driving behavior of the autonomous vehicle based on the generated driving trajectory.

Furthermore, in the present specification, the step of generating the driving trajectory is characterized by comprising the step of: predicting the future driving trajectory through inputs from past driving trajectories derived from the learning dataset; and updating the parameters of the reinforcement learning model to maximize the reward between the predicted future driving trajectory and the actual driving trajectory.

Furthermore, in the present specification, the method for determining the driving behavior is characterized by further comprising the steps of: performing learning in the order of low driving difficulty to high driving difficulty; and conducting progress evaluation for each driving difficulty.

The present specification has the effect of overcoming the limitations of rule-based systems (where it is impossible for the autonomous driving decision developer to define all driving situations and implement algorithms for them) by generating algorithms for various driving situations through reinforcement learning from real-world driving datasets, using artificial intelligence.

Furthermore, the present specification has the effect of allowing more efficient response to new situations, by performing additional learning with situation-specific datasets, instead of the difficulty of analyzing existing situations, defining rules, and developing corresponding algorithms for each new scenario.

The effects that can be achieved by the present invention are not limited to those mentioned above. Other unmentioned effects may become clearly understood by a person skilled in the relevant technical field based on the descriptions provided below.

### BRIEF DESCRIPTION OF THE DRAWINGS

The accompanying drawings, which are included as part of the detailed description to aid in understanding the present invention, provide embodiments of the invention and illustrate the technical features of the present invention along with the detailed description.

FIG. 1 is an exemplary block diagram illustrating the internal structure of the driving behavior determination apparatus for generating the final trajectory of autonomous driving, as proposed in the present specification.

FIG. 2 is an exemplary block diagram illustrating the internal structure of a decision module to which the reinforcement learning method proposed in the present specification can be applied.

FIG. 3 is an embodiment illustrating the method for generating the reinforcement learning dataset proposed in the present specification.

FIG. 4 is an embodiment illustrating the classification of driving difficulty proposed in the present specification.

FIG. 5 is an embodiment illustrating the reinforcement learning dataset proposed in the present specification.

FIG. 6 and FIG. 7 are embodiments illustrating the reinforcement learning method for predicting future trajectories that maximize the reward, as proposed in the present specification.

FIG. 8 is a flowchart illustrating an embodiment of the method for determining the driving behavior of an autonomous vehicle through reinforcement learning, as proposed in the present specification.

### DETAILED DESCRIPTION

The technical terms used in the present specification are employed solely for the purpose of describing specific embodiments and are not intended to limit the scope of the technology disclosed herein. Moreover, unless explicitly defined otherwise in the present specification, the technical terms used herein should be interpreted according to their generally understood meaning by a person skilled in the relevant field of technology to which the disclosed technology pertains. These terms should not be interpreted in an overly broad or overly narrow manner. Furthermore, if any technical terms used in the present specification do not accurately express the concepts of the disclosed technology, they should be understood as being replaced with terms that a person skilled in the relevant field would correctly understand. General terms used in the specification should be interpreted according to their dictionary definitions or according to the context in which they are used, and should not be interpreted in an overly narrow sense.

Terms such as “first,” “second,” and the like, which include ordinal numbers, may be used to describe various components, but these components should not be limited by these terms. These terms are used solely for the purpose of distinguishing one component from another. For example, without departing from the scope of the present invention, a first component may be referred to as a second component, and similarly, a second component may be referred to as a first component.

Hereinafter, the embodiments disclosed in the present specification will be described in detail with reference to the accompanying drawings. Identical or similar components are assigned the same reference numerals, and redundant descriptions of these components will be omitted.

In describing the technology disclosed in the present specification, detailed explanations of related prior art are omitted if it is determined that such explanations could obscure the essence of the disclosed technology. Additionally, the accompanying drawings are provided solely to facilitate an understanding of the concepts of the disclosed technology and should not be interpreted as limiting the scope of the technology disclosed therein.

The conventional autonomous driving path generation system is composed of a perception system, a global path planning system, a decision-making system, and a control system. The decision-making system receives perception results from the perception system and performs complex processes such as collision risk analysis, driving behavior determination, and path generation, ultimately generating the final trajectory of the autonomous driving vehicle, which is then transmitted to the control system.

In contrast, the present specification provides a method for generating the final trajectory of autonomous driving without performing the complex processes of the decision-making system, by using a reinforcement learning artificial neural network.

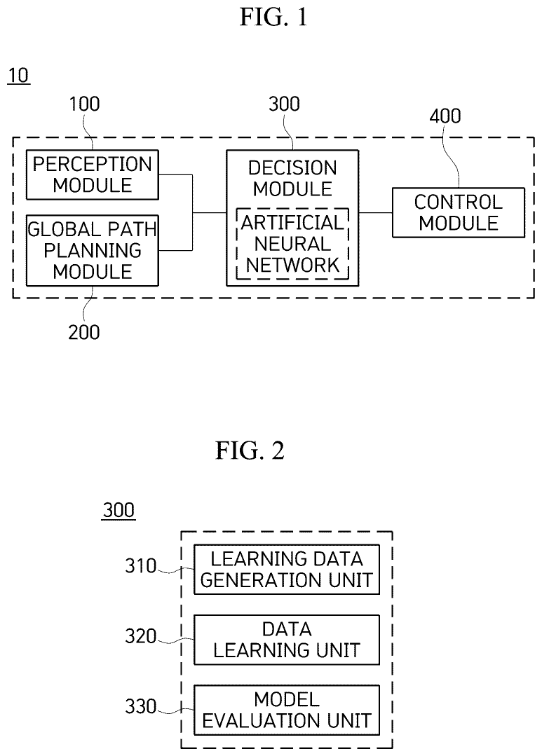

FIG. 1 is an exemplary block diagram illustrating the internal structure of the driving behavior determination apparatus for generating the final trajectory of autonomous driving, as proposed in the present specification.

Referring to FIG. 1, the driving behavior determination apparatus (10) proposed in the present specification may include a perception module (100), a global path planning module (200), a decision module (300), and a control module (400).

The perception module (100) provides the ego position, object information, and prediction information to the decision module, and the global path planning module (200) provides information about the global path to the decision module.

More specifically, the perception module collects driving logging data from all directions of the autonomous vehicle through multiple sensors and recognizes dynamic and static objects in the surrounding environment.

The decision module (300) receives the perception results from the perception module and generates the final trajectory through a reinforcement learning artificial neural network.

The generated final trajectory refers to the driving path the autonomous vehicle must follow, and is a list of waypoints that include position, speed, and direction.

More specifically, the decision module generates a learning dataset from the driving logging data, classifies the learning dataset by scenario and driving difficulty, predicts the future driving trajectory through past driving trajectories from the learning dataset, and generates the driving trajectory of the autonomous vehicle by updating the parameters of the reinforcement learning model to maximize the reward between the predicted future driving trajectory and the actual driving trajectory through learning.

The driving behavior determination apparatus is a computing apparatus capable of training a neural network and can be implemented as various electronic devices such as vehicles, servers, desktop PCs, laptop PCs, tablet PCs, or portable terminals.

The driving behavior determination apparatus may further include a memory (not shown) for storing various programs and data necessary for the operation of the device. The memory can be implemented as non-volatile memory, volatile memory, flash memory, hard disk drives (HDD), or solid-state drives (SSD). Furthermore, the memory may store the neural network model generated through the learning algorithm for reinforcement learning, according to an embodiment of the present specification.

The control module (400) controls the driving behavior of the autonomous vehicle based on the generated driving trajectory of the vehicle.

FIG. 2 is an exemplary block diagram illustrating the internal structure of a decision module to which the reinforcement learning method proposed in the present specification can be applied.

The decision module (300) includes an artificial neural network model and may be referred to as an AI device, AI module, AI processor, etc. It may be configured to include a learning data generation unit (310), a data learning unit (320), and a model evaluation unit (330) in order to perform the reinforcement learning method proposed in the present specification.

Additionally, the decision module may further store various programs and data necessary for its operation. The memory (25) can be implemented as non-volatile memory, volatile memory, flash memory, hard disk drive (HDD), or solid-state drive (SSD), and etc.

The learning data generation unit (310) extracts data related to reinforcement learning from the driving logging data, generates a learning dataset, and classifies the generated dataset by scenario and driving difficulty.

The learning dataset may include ego information, object information surrounding the autonomous vehicle, rear light information of a vehicle located ahead of the autonomous vehicle, signal information from traffic lights, and information about the drivable area of the autonomous vehicle. The ego information may include the position, size, direction, speed, and steering angle of the autonomous vehicle. The surrounding object information may include information about dynamic objects and static objects in the surrounding environment.

The classification by scenario may involve classification based on road structure analysis through matching the driving position of the autonomous vehicle with data from a high-definition map (HDMap), or classification based on the motion information of the autonomous vehicle caused by surrounding vehicles using the behavioral information of the autonomous vehicle.

And the driving difficulty may be classified based on collision risk. The collision risk can be calculated by predicting the future trajectories of surrounding dynamic objects and the actual driving trajectory of the autonomous vehicle, and then calculating the object collision probability based on this information.

The data learning unit (320) predicts the future driving trajectory through inputs from past driving trajectories derived from the learning dataset, and updates the parameters of the reinforcement learning model to maximize the reward between the predicted future driving trajectory and the actual driving trajectory, thereby performing the learning process.

The reward may include safety-related rewards defined by the autonomous driving failure rate, efficiency-related rewards defined by the autonomous driving progress rate, and comfort-related rewards defined by the ride comfort, which may be measured by the deceleration rate.

The model evaluation unit (330) performs learning in the order of low driving difficulty to high driving difficulty and conducts progress evaluation for each driving difficulty.

The model evaluation unit inputs evaluation data into the neural network model, and if the analysis results output from the evaluation data do not meet predetermined criteria, it can instruct the data learning unit to perform additional learning. In this case, the evaluation data may be pre-defined data used to evaluate the reinforcement learning model. For example, if the number or ratio of evaluation data with inaccurate analysis results from the trained reinforcement learning model exceeds a predetermined threshold, the model evaluation unit may determine that the results do not meet the criteria.

The reinforcement learning-based decision-making method performed by the decision module of the autonomous driving behavior determination apparatus proposed in the present specification can be carried out through three main processes: (1) data collection and construction of the reinforcement learning dataset, (2) performing reinforcement learning using the learning dataset, and (3) integrating the trained artificial neural network into the autonomous vehicle. The data collection may be performed by at least one of the perception module or the decision module. The three processes mentioned above will be discussed in more detail with reference to the relevant drawings.

### Data Collection and Construction of the Reinforcement Learning Dataset

The driving behavior determination apparatus collects (or acquires) the data (or datasets) necessary for reinforcement learning. The data required for reinforcement learning may include ego information (vehicle position, speed, orientation, etc.) from all directions, movement information of surrounding dynamic objects (position, direction, speed, etc. of dynamic objects), information about static objects, traffic light information, and high-definition map data.

The reason for the need for ego information and vehicle information from all directions is for the autonomous vehicle to perform tasks such as passing intersections, merging, lane changing, and avoidance.

Therefore, to acquire the vehicle information from all directions, the driving behavior determination apparatus collects data using a vehicle (or collection vehicle, autonomous vehicle) equipped with sensors in all directions.

The collected (or stored) data may include GPS location information, raw data from cameras/LiDAR sensors, and in-vehicle sensor information (such as wheel speed, steering angle, yaw direction, speed, etc.) that can capture the motion information (or behavioral data) of the collection vehicle. And the driving behavior determination apparatus generates a reinforcement learning dataset through the learning dataset generation unit based on the collected (or stored or logged) data.

Specifically, the driving behavior determination apparatus can generate the reinforcement learning dataset through processes such as automatic extraction of ego information and surrounding object information, automatic scenario classification, and automatic driving difficulty classification.

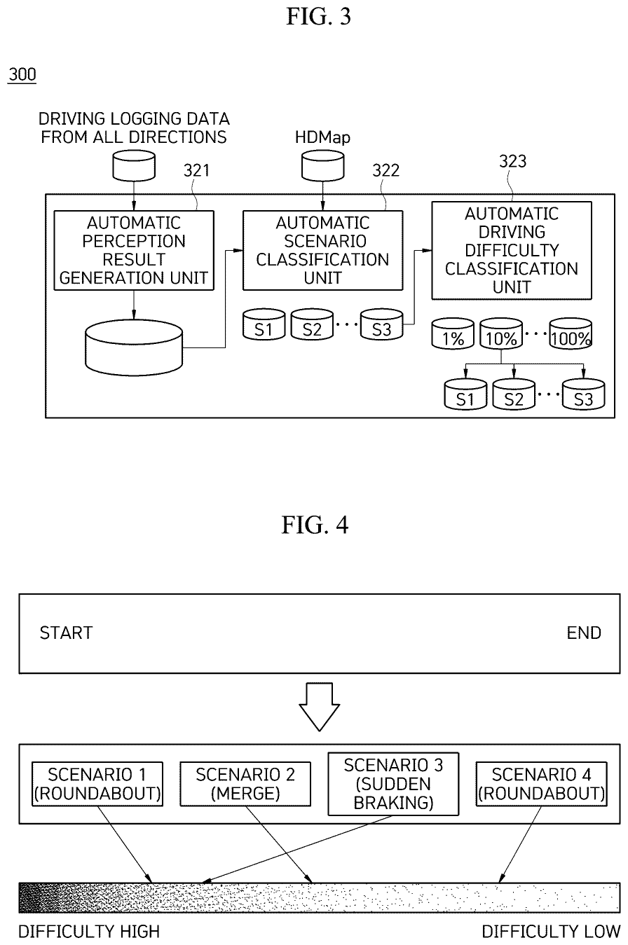

FIG. 3 is an embodiment illustrating the method for generating the reinforcement learning dataset proposed in the present specification. Referring to FIG. 3, the learning dataset generation unit generates the learning dataset for reinforcement learning through an automatic perception result generation unit (321), an automatic scenario classification unit (322), and an automatic driving difficulty classification unit (323).

The automatic perception result generation unit automatically extracts ego information and surrounding object information from the collected all-direction driving logging data. That is, the automatic perception result generation unit receives the all-direction driving logging data as batch input and automatically extracts the ego information and surrounding object information.

The ego information may include the ego (autonomous vehicle) position, size, direction, speed, and steering angle. The ego position does not rely on GPS location. This is because GPS has errors, making accurate position determination impossible. Instead, the exact ego position is calculated using localization techniques based on cameras, LiDAR sensors, and high-precision maps or point cloud maps.

And the surrounding object information may include information about surrounding dynamic objects, rear light information of a vehicle ahead (or in front), signal information from traffic lights, static object information, and information about the drivable area.

The surrounding dynamic object information may include the position, size (3D bounding box), direction, and speed of surrounding dynamic objects (e.g., cars, pedestrians, cyclists, etc.). The static object information may include information about static objects that need to be avoided, such as drums or traffic cones. The drivable area information may include the drivable areas of roads without lanes.

The reason for extracting the ego information and surrounding object information through the automatic perception result generation unit is to utilize more surrounding information in order to determine the optimal behavior of the autonomous vehicle.

Furthermore, in order to perform reinforcement learning based on real-world datasets from various situations or environments, rather than simulations, the driving behavior determination apparatus classifies various scenarios based on the collected data for use in reinforcement learning. The scenario classification unit classifies the scenarios to derive consistent performance in the learning results for each scenario.

Here, the automatic classification of scenarios can be performed based on two criteria: (1) road structure analysis and (2) interaction with surrounding objects.

First, scenario classification based on road structure analysis involves automatically classifying driving scenarios using high-definition maps (HDMap). The classification is performed by matching the position of the vehicle with high-definition map data for scenarios such as straight roads, curved roads, roundabouts, signal/non-signal intersections, merges, branches, overpasses, underpasses, tunnels, etc.

Additionally, scenario classification based on interaction analysis with surrounding objects involves automatically classifying driving scenarios based on the vehicle's motion information caused by surrounding vehicles, such as sudden braking, sharp steering, cutting in, yielding, etc., using the vehicle's behavioral data.

The scenario classification unit divides and stores the driving data, automatically extracted from perception results, into segments of approximately 10 to 15 seconds. This is done to consistently divide and store the data based on the time covering each scenario.

Next, the automatic driving difficulty classification unit distinguishes between easy and difficult driving situations and automatically classifies the driving difficulty in order to perform reinforcement learning while maintaining consistent performance in each situation. The classification of driving difficulty can occur simultaneously with the classification of scenarios. In other words, the driving difficulty classification unit can calculate the driving difficulty for each scenario.

The driving difficulty classification unit can classify the driving difficulty based on “collision risk” as the classification criterion. Here, the collision risk is higher when there is a larger magnitude of sudden deceleration (or deceleration rate) and sharp steering (or steering angle speed) in the vehicle's behavioral data.

Additionally, the automatic driving difficulty classification unit calculates the collision risk by predicting the future trajectories of surrounding dynamic objects and the vehicle's trajectory, and computes the object collision probability to determine the collision risk.

The driving difficulty based on the calculated collision risk is quantitatively calculated in levels such as 1%, 10%, 50%, and 100%, and is used in the learning process.

FIG. 4 is an embodiment illustrating the classification of driving difficulty proposed in the present specification. Referring to FIG. 4, it can be seen that the driving difficulty is set differently for each scenario, such as Scenario 1 (roundabout), Scenario 2 (merge), Scenario 3 (sudden braking), and Scenario 4 (roundabout).

The driving behavior determination apparatus classifies and stores the final generated reinforcement learning dataset by difficulty and scenario. The final form of the stored reinforcement learning dataset is a continuous data sequence of scenes, each lasting 10 to 15 seconds (predefined as a single time interval). The scene may include a road graph, which is raster data of the corresponding section's HDMap, as well as information automatically generated by the automatic perception result generation unit.

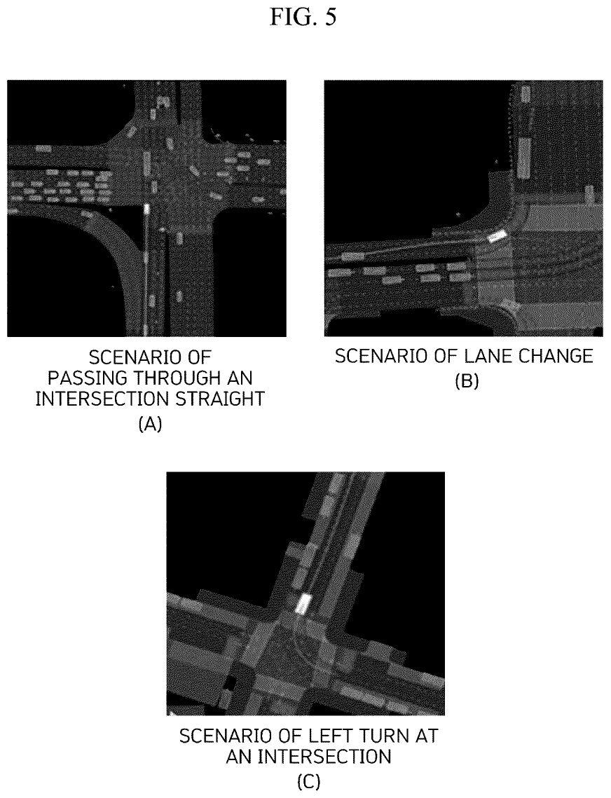

FIG. 5 is an embodiment illustrating the reinforcement learning dataset proposed in the present specification. More specifically, FIG. 5a represents a scenario of passing through an intersection straight, FIG. 5b represents a lane change scenario, and FIG. 5c represents a left turn at an intersection scenario.

Next, we will examine the method for performing reinforcement learning using the final generated reinforcement learning dataset.

The driving behavior determination apparatus performs autonomous driving reinforcement learning by replaying (replaying) a 10 to 15-second learning dataset through the data learning unit. The autonomous driving reinforcement learning trains the model to maximize the defined reward. Through the learning by the data learning unit, the intelligence of the ego vehicle gradually increases, which is reflected in the replay of the ego, resulting in the generation of a trajectory that allows for the optimal autonomous driving behavior.

The reinforcement learning reward may be defined in three categories: safety reward, efficiency reward, and comfort reward.

First, let's look at the safety reward. The safety-related reward is defined as the “autonomous driving failure rate,” and the data learning unit of the driving behavior determination apparatus performs learning to minimize the autonomous driving failure rate. In the case of a collision or lane departure (from the centerline or road boundary), the data learning unit considers it a failure and calculates the autonomous driving failure rate through the replay of the entire real-world dataset.

Next, let's examine the efficiency reward. The efficiency-related reward is defined as the “autonomous driving progress rate”, and the data learning unit performs learning to maximize the autonomous driving progress rate. The autonomous driving progress rate is calculated by measuring the distance traveled within a specified time during the replay of each scenario. The progress rate increases when the vehicle drives more quickly (by increasing speed or performing evasive maneuvers, etc.).

Next, let's look at the comfort reward. The comfort-related reward is defined as the ride comfort in autonomous driving and is measured by the deceleration rate. Here, the weight of each reward category (safety, efficiency, comfort) may vary depending on the difficulty. The weight of the safety category is set highest, and when safety is ensured, learning may be performed to increase the rewards for efficiency and comfort categories.

The data learning unit, for example, derives a future predicted trajectory from the learned driving policy intelligence (which initially has no intelligence) based on 1 second of past trajectory (driving situation—automatically extracted information) from a 10-second driving dataset as input. It then performs reinforcement learning by updating the parameters of the learning model to maximize the reward loss (predicted reward actual reward) for the 9-second future (actual) trajectory in terms of safety, efficiency, and comfort, thereby generating the driving policy intelligence.

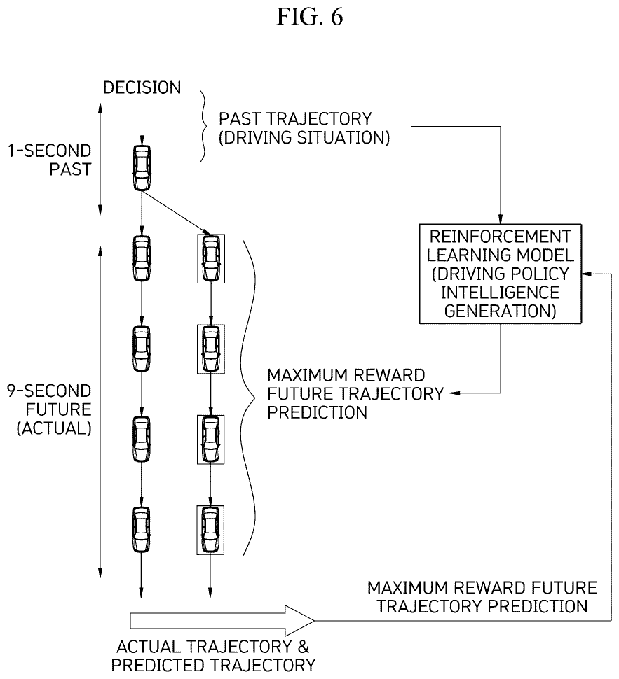

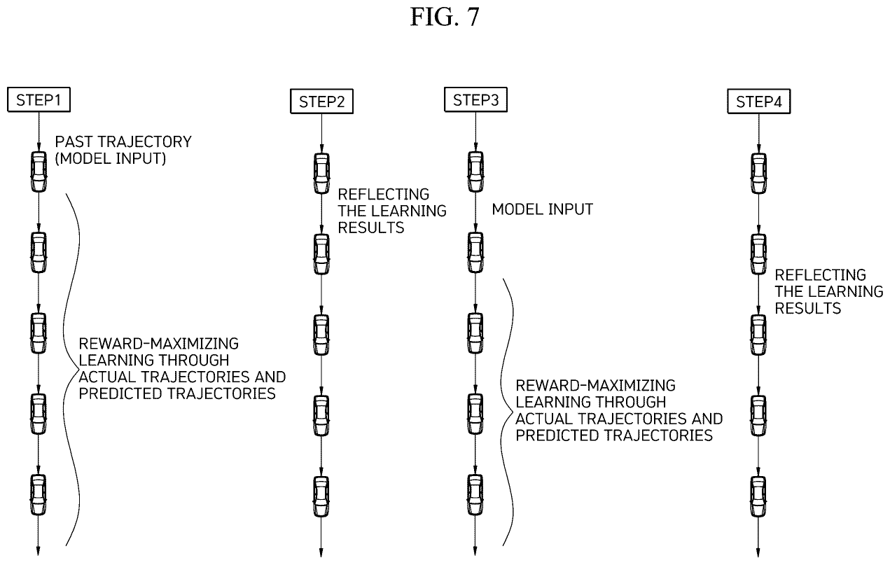

FIG. 6 and FIG. 7 are embodiments illustrating the reinforcement learning method for predicting future trajectories that can maximize the reward, as proposed in the present specification. FIG. 7 shows the case where the reinforcement learning method from FIG. 6 is performed iteratively.

Referring to FIG. 6, the data learning unit performs reinforcement learning by replaying the 10-second learning dataset. In other words, learning by the reinforcement learning model in the data learning unit predicts the 9-second future trajectory from the 1-second input of the past trajectory and repeatedly updates the model parameters to maximize the reward, which can improve the driving policy intelligence of the reinforcement learning model.

Referring to FIG. 7, it can be seen that the reinforcement learning method from FIG. 6 is repeatedly performed through steps 1 to 4. That is, the data learning unit generates the driving policy intelligence by training the reinforcement learning model iteratively to produce the future predicted trajectory that maximizes the reward, as shown in FIG. 7.

Therefore, driving policy intelligence, capable of determining the optimal driving behavior through numerous learning processes from the driving datasets for various situations (scenarios, difficulty levels), is generated.

Next, let's explore the reinforcement learning strategies to improve the effectiveness (or performance) of the learning. The reinforcement learning strategy may be divided into (1) automatic learning based on learning progress evaluation and (2) reinforcement learning policy (neural network) correction. And the reinforcement learning strategy may be performed by the model evaluation unit of the driving behavior determination apparatus.

First, automatic learning based on learning progress evaluation starts with easy situations (low difficulty) and gradually performs learning for more difficult driving situations.

The model evaluation unit of the driving behavior determination apparatus performs progress evaluation for each difficulty level to ensure consistent performance based on difficulty. This involves evaluating whether the performance metrics for the already examined safety, efficiency, and comfort meet the target performance. If performance is lacking, the unit automatically selects the corresponding dataset for that difficulty level and performs additional learning.

Next, the driving behavior determination apparatus performs reinforcement learning policy (artificial neural network) correction. Even if the learning with the constructed dataset satisfies the target performance, the constructed dataset may not include all driving situations. Therefore, the learned driving policy artificial neural network is simultaneously integrated with the autonomous driving perception, decision, and control systems to log data continuously during autonomous driving. For new situations (i.e., situations where performance degrades), continuous learning is required. Therefore, the driving behavior determination apparatus logs data simultaneously during driving to build a learning dataset for situations where performance degrades and performs learning on it, that is, carrying out reinforcement learning policy calibration, in other words, additional learning, to ensure higher performance.

The driving behavior determination apparatus integrates the driving policy artificial neural network generated through the previously discussed reinforcement learning with the perception module and the control module, and embeds the software implementing the method proposed in the present specification into the autonomous vehicle to perform real-world driving validation.

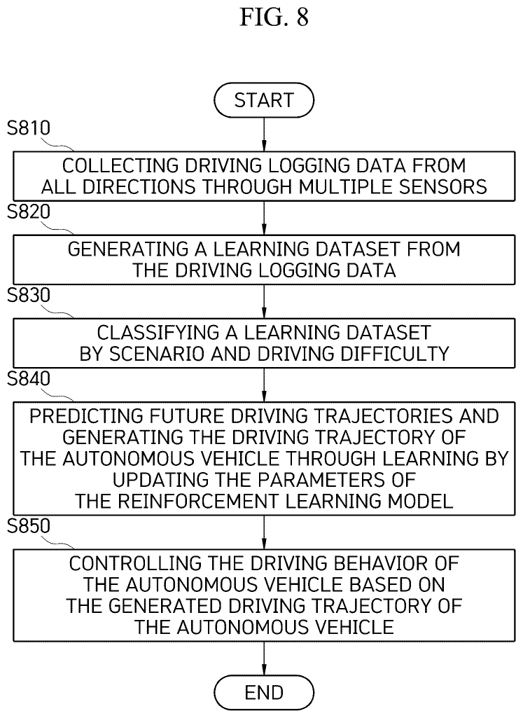

FIG. 8 is a flowchart illustrating an embodiment of the method for determining the driving behavior of an autonomous vehicle through reinforcement learning, as proposed in the present specification.

The driving behavior determination apparatus collects driving logging data from all directions of the autonomous vehicle through multiple sensors (S810). The driving behavior determination apparatus then generates a learning dataset from the driving logging data (S820).

The learning dataset may include ego information, object information surrounding the autonomous vehicle, rear light information of a vehicle located ahead of the autonomous vehicle, signal information from traffic lights, and information about the drivable area of the autonomous vehicle. The ego information may include the position, size, direction, speed, and steering angle of the autonomous vehicle. The surrounding object information may include information about dynamic objects and static objects in the surrounding environment. The driving behavior determination apparatus classifies the learning dataset by scenario and driving difficulty (S830).

The scenario classification may involve classification through road structure analysis by matching the driving position of the autonomous vehicle with data from a high-definition map (HDMap), or classification based on the motion information of the autonomous vehicle caused by surrounding vehicles using the vehicle's behavioral data. The classification by driving difficulty may be based on collision risk.

Additionally, the collision risk may be calculated by determining the object collision probability based on the predicted future trajectory information of surrounding dynamic objects and the actual driving trajectory of the autonomous vehicle.

And the driving behavior determination apparatus, based on the classified learning dataset, predicts the future driving trajectory and generates the driving trajectory of the autonomous vehicle by updating the parameters of the reinforcement learning model to maximize the reward through learning (S840).

More specifically, the driving behavior determination apparatus predicts the future driving trajectory through input from past driving trajectories derived from the learning dataset, and updates the parameters of the reinforcement learning model to maximize the reward between the predicted future driving trajectory and the actual driving trajectory. Then, based on the generated driving trajectory of the autonomous vehicle, the driving behavior determination apparatus controls the driving behavior of the autonomous vehicle (S850).

Additionally, in step S840, the driving behavior determination apparatus performs learning in the order of low driving difficulty to high driving difficulty and may conduct progress evaluation for each driving difficulty.

The embodiments described above represent combinations of the components and features of the present invention in a particular form. Each component or feature should be considered optional unless explicitly stated otherwise. Each component or feature can be implemented in a form that is not combined with other components or features. Additionally, it is possible to combine some components and/or features to form embodiments of the present invention. The order of operations described in the embodiments of the present invention may be changed. Some components or features of one embodiment may be included in another embodiment or replaced with corresponding components or features of another embodiment. It is apparent that claims not explicitly citing each other can be combined to form embodiments or be included as new claims through amendments after filing.

Embodiments of the present invention can be implemented by various means, such as hardware, firmware, software, or combinations thereof. In the case of hardware implementation, one or more embodiments of the present invention may be implemented by ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, microcontrollers, microprocessors, or the like.

In the case of firmware or software implementation, one embodiment of the present invention may be implemented as modules, procedures, or functions that perform the functions or operations described above. The software code can be stored in memory and executed by a processor. The memory may be located either inside or outside the processor and can exchange data with the processor by various well-known means.

It is apparent to those skilled in the art that the present invention may be embodied in other specific forms without departing from the essential features of the invention. Therefore, the above detailed description should not be construed as limiting in any way, but should be considered as illustrative. The scope of the invention should be determined by the reasonable interpretation of the appended claims, and any modifications within the equivalent scope of the invention are included within the scope of the invention.

What is claimed is:

1. A driving behavior determination apparatus for determining the driving behavior of an autonomous vehicle through reinforcement learning, comprising:
a perception module that collects driving logging data from all directions of the autonomous vehicle through multiple sensors and recognizes surrounding dynamic and static objects;
a decision module that generates a learning dataset from the driving logging data, classifies the learning dataset by scenario and driving difficulty, predicts the future driving trajectory based on past driving trajectories from the learning dataset, and generates the driving trajectory of the autonomous vehicle by updating the parameters of a reinforcement learning model to maximize the reward between the predicted future driving trajectory and the actual driving trajectory; and
a control module that controls the driving behavior of the autonomous vehicle based on the generated driving trajectory.

2. The driving behavior determination apparatus according to claim 1, wherein the decision module comprises:
a learning dataset generation unit that extracts data related to reinforcement learning from the driving logging data and generates a learning dataset, and classifies the generated learning dataset by scenario and driving difficulty; and
a data learning unit that predicts the future driving trajectory from the inputs of past driving trajectories derived from the learning dataset and updates the parameters of the reinforcement learning model to maximize the reward between the predicted future driving trajectory and the actual driving trajectory.

3. The driving behavior determination apparatus according to claim 1, wherein the decision module further comprises a model evaluation unit that performs learning in the order of low driving difficulty to high driving difficulty and conducts progress evaluation for each driving difficulty.

4. The driving behavior determination apparatus according to claim 1, wherein the learning dataset comprises:
ego information,
object information surrounding the autonomous vehicle,
rear light information of a vehicle located ahead of the autonomous vehicle,
signal information from traffic lights, and
information about the drivable area of the autonomous vehicle.

5. The driving behavior determination apparatus according to claim 4, wherein the ego information comprises:
a position, size, direction, speed, and steering angle of the autonomous vehicle.

6. The driving behavior determination apparatus according to claim 4, wherein the object information comprises information about surrounding dynamic objects and static objects.

7. The driving behavior determination apparatus according to claim 1, wherein the classification by scenario is performed based on:
road structure analysis through matching the driving position of the autonomous vehicle with data from a high-definition map (HDMap); or
the motion information of the autonomous vehicle caused by surrounding vehicles using the behavioral data of the autonomous vehicle.

8. The driving behavior determination apparatus according to claim 1, wherein the driving difficulty classified by the decision module is based on collision risk.

9. The driving behavior determination apparatus according to claim 8, wherein the collision risk is calculated by determining the object collision probability based on the predicted future trajectory information of surrounding dynamic objects and the actual driving trajectory of the autonomous vehicle.

10. The driving behavior determination apparatus according to claim 1, wherein the reward comprises:
a safety-related reward based on the autonomous driving failure rate;
an efficiency-related reward based on the autonomous driving progress rate; and
a comfort-related reward defined by the ride comfort, which is measured by the deceleration rate.

11. A method for determining the driving behavior of an autonomous vehicle through reinforcement learning, comprising the steps of:
collecting driving logging data from all directions of the autonomous vehicle through multiple sensors;
generating a learning dataset from the driving logging data;
classifying the learning dataset by scenario and driving difficulty;
predicting the future driving trajectory based on the classified learning dataset and updating the parameters of the reinforcement learning model to maximize the reward, thereby generating the driving trajectory of the autonomous vehicle; and
controlling the driving behavior of the autonomous vehicle based on the generated driving trajectory.

12. The method according to claim 11, wherein the step of generating the driving trajectory comprises:
predicting the future driving trajectory through inputs from past driving trajectories derived from the learning dataset; and
updating the parameters of the reinforcement learning model to maximize the reward between the predicted future driving trajectory and the actual driving trajectory.

13. The method according to claim 11, further comprising:
performing learning in the order of low driving difficulty to high driving difficulty; and
conducting progress evaluation for each driving difficulty.

14. The method according to claim 11, wherein the learning dataset comprises:
ego information,
object information surrounding the autonomous vehicle,
rear light information of a vehicle located ahead of the autonomous vehicle,
signal information from traffic lights, and
information about the drivable area of the autonomous vehicle.

15. The method according to claim 14, wherein the ego information comprises a position, size, direction, speed, and steering angle of the autonomous vehicle.

16. The method according to claim 14, wherein the object information surrounding the autonomous vehicle comprises:
information about surrounding dynamic objects; and
information about surrounding static objects.

17. The method according to claim 11, wherein the classification by scenario is performed based on:
road structure analysis through matching the driving position of the autonomous vehicle with data from a high-definition map (HDMap); or
motion information of the autonomous vehicle caused by surrounding vehicles using the behavioral information of the autonomous vehicle.

18. The method according to claim 11, wherein the classification by driving difficulty is based on collision risk.

19. The method according to claim 18, wherein the collision risk is calculated by determining the object collision probability based on the predicted future trajectory information of surrounding dynamic objects and the actual driving trajectory of the autonomous vehicle.
